(19) United States
(12) Patent Application Publication
(10) Pub. No.: US 2001/0003939 A1
(43) Pub. Date: Jun. 21, 2001

(54) AUTOMATIC CARTON SLITTING MACHINE

(76) Inventors: SHENG-FENG LIU, TAO YUAN (TW); CHIN-LU HUANG, TAO YUAN (TW); WEI CHANG, HSINCHU (TW); HAI-JOUR SUN, MIAOLI (TW); SHIUAN-I SHAU, TAICHUNG (TW)

Correspondence Address: W. WAYNE LIAUH, LAW OFFICE OF LIAUH AND ASSOCIATES, 4224 WAIALAE AVE, STE. 5-388, HONOLULU, HI, 96816

(21) Appl. No.: 09/268,744

(22) Filed: Mar. 13, 1999

(51) Int. Cl. B26D 1/14

(52) U.S. Cl. 83/800; 83/76.8; 83/76.1; 83/72

(57) ABSTRACT

An automatic carton slitting machines includes a transmission means for moving cartons, a sensing and positioning means for detecting and positioning the cartons at locations desired, a slitting means for slitting the carton and a control unit for coordinate and control the operations of all other means. The cutter means includes two spaced cutter sets each has a motor driven rotating saw cutter with adjustable slitting angle. One of the cutter sets is movable by a cutter set moving means for changing spacing distance between the cutter sets to process carton of different width. The cutter means also has a frame lifting means to adjust cutter sets height for processing cartons of different height. Through coordinating the transmission means, cutter set moving means and frame lifting means may coordinate their motion so that the cutter sets may move in three dimensions against the carton for automatically cleaving cartons of different size.

### BACKGROUND OF THE INVENTION

1. Field of the Invention

This invention relates to an automatic carton slitting machine and particularly to an automatic carton slitting machine for slitting upper lid of carton of different sizes.

2. Description of the Prior Art

For mass merchandisers, chain stores, big wholesalers, large distributors and the like, there is a need for processing huge amount of goods containing in cartons of various sizes. It takes a great deal of manpower to slit and open the cartons to take out the goods for display or sales. Traditionally this carton handling work is done by people using a knife to slit open the four lateral sides of the carton top lid. It is a labor intensive and time consuming job. Moreover people may get hurt by knife accidentally and results in a drop of work efficiency.

There is a semiautomatic carton slitting machinery being developed for improving the carton slitting operation set forth above. It usually needs operators to press buttons to perform the required operations. Moreover one machine usually can handle only one size of carton. There is still a lot of room for improvement regard its work efficiency and flexibility.

### SUMMARY OF THE INVENTION

In view of aforesaid disadvantages, it is therefore an object of this invention to provide an automatic carton slitting machine that is able to slit automatically the top lids of cartons of different sizes for achieving higher efficiency, greater flexibility and improved safety for workers.

It is another object of this invention to provide an automatic carton slitting machine that may slit two lateral sides of cartons. When aligning two such machines in series and normal to each other all four lateral sides of the top lids may be cut open automatically at high speed with consistent quality.

### BRIEF DESCRIPTION OF THE DRAWINGS

The invention, as well as its many advantages, may be further understood by the following detailed description and drawings in which:

FIG. 1 is a front view of this invention.

FIG. 2 is a side view of this invention.

FIG. 3 is a top view of this invention.

FIG. 4 is a schematic top view of two sets of this invention arranged in series and normal to each other.

### DETAILED DESCRIPTION OF THE PREFERRED EMBODIMENT

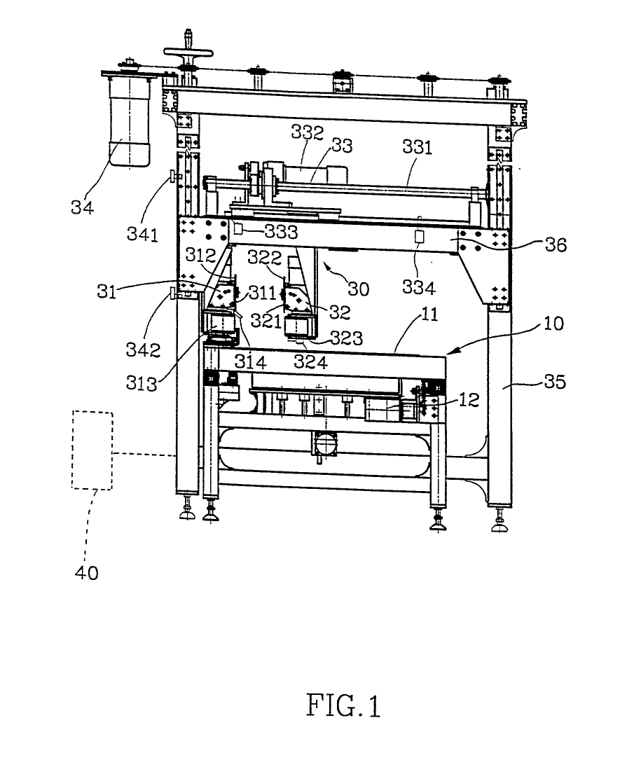

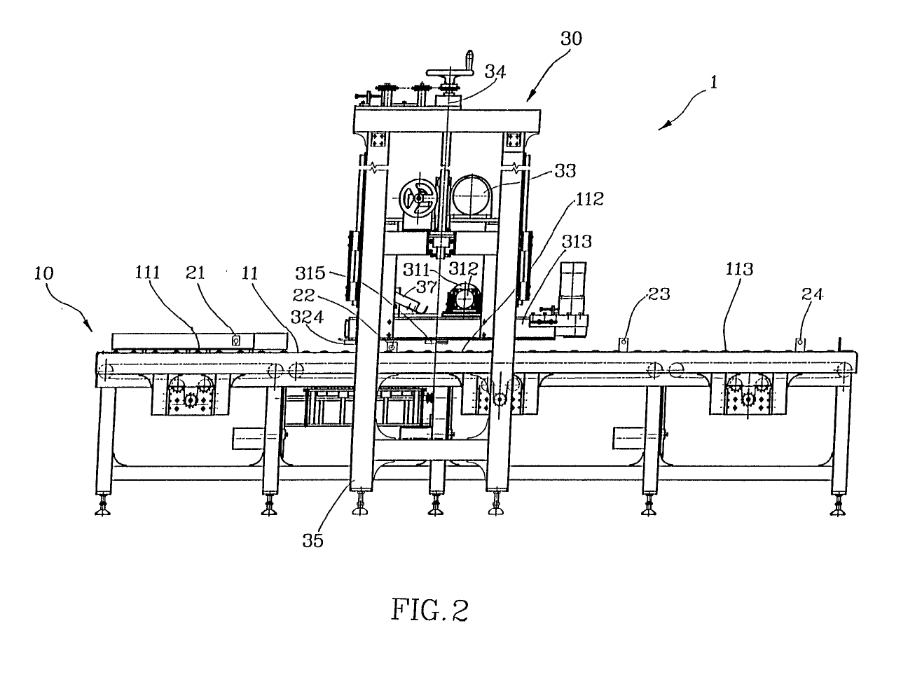

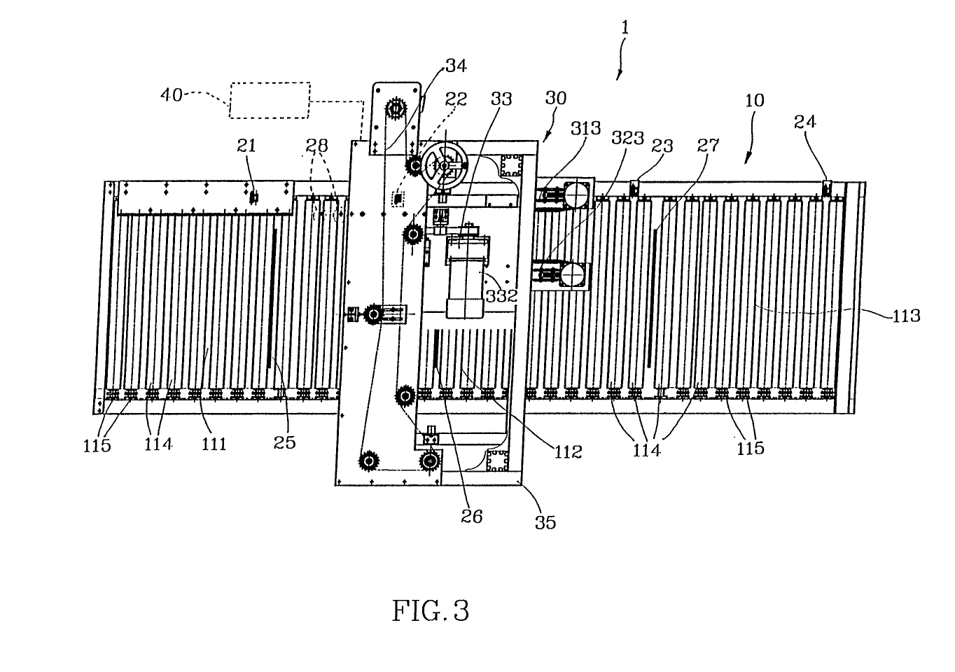

Referring to FIGS. 1, 2 and 3, a preferred embodiment of this invention includes a transmission means 10, a sensing and positioning means, a slitting means 30 and a control unit 40 which wires to aforesaid means and controls and coordinates the interaction among various means for automatic operation. The transmission means 10 includes a conveyor 11 which consists of a plurality of roller bars 114 each has a sprocket 115 (or an idler) at one end engaging with a chain (or belt) and driven by a motor 12. Therefore the roller bars 114 may be turned at same direction simultaneously for moving cartons placed upon the conveyor 11 in a first direction (i.e. longitudinal). The conveyor 11 may be divided separately in a waiting zone 111, a slitting zone 112 and a discharging zone 113.

The sensing and positioning means includes a plurality of sensors 21, 22, 23 and stoppers 25, 26, 27 spacely located in the transmission means 10. The sensors may detect the moving positions of the cartons and then trigger the first stopper 25 to hold a first carton at the waiting zone 111, the second stopper 26 to hold a second carton at the slitting zone 112 and the third stopper 27 to hold a third carton at the discharging zone 113. Each of the stoppers 25, 26 and 27 is formed like a plank and located between two roller bars 114, and may be moved above the roller bars 114 by means of a motor, a solenoid valve, a hydraulic cylinder, an air cylinder or the like for stopping a carton from moving forward, and may also be moved below the roller bars 114 to enable the carton moving forward.

The sensors 21, 22 and 23 may be photo sensors or mechanical microswitches. The first sensor 21 aims for detecting if the first carton being properly located in the waiting zone 111. The second sensor 22 aims for detecting if the second carton being properly located in the slitting zone 112 for slitting operation. The third sensor 23 aims for detecting if the third carton being properly located in the discharging zone 113. A four sensor 24 may be added at the end of the discharging zone 113 to detect if the processed carton has been moved out of the discharging zone 113.

In the slitting zone 112, there may further be provided with a plural number of width guide posts 28 along a lateral side of the slitting zone for guiding the cartons moving in the correct direction without skewing sideward. The width guide posts 28 are engaged with the second stopper 26 by means of a cam means or the like so that when the second stopper 26 is moved downward for starting slitting operation, the width guide posts 28 will also be moved downward for the carton be moved to a first cutter set 31.

The slitting means 30 is located in the slitting zone 112. It includes the first cutter set 31, a second cutter set 32, a cutter set moving means 33, a frame lifting means 34 and a stand 35 for supporting all the other means of the slitting means 30 set forth above.

The first cutter set 31 is stationarily mounted on a cutter rack 36. The cutter set moving means 33 may move the second cutter set 32 in a second direction (i.e., transversely) relative to the first direction so that the distance between the first cutter set 31 and the second cutter set 32 may be changed to suit different width of carton. The first and second cutter sets 31 and 32 have respectively a rotating cutter saws 312 and 322 driven by motors 311 and 321. The cutting angle of the cutter sets 31 and 32 may be automatically or manually adjusted such as from 90 degrees (normal slitting) to 45 degrees or 60 degrees or other angles desired. The cutter sets 31, 32 and the cutter set moving means 33 are mounted on the cutter rack 36 which is movable in a third direction (i.e. up or down) against the first and second directions by means of the frame lifting means 34. The cutter rack 36 and the frame lifting means 34 in turn are mounted on a stand 35 which is fixedly located above the slitting zone 112.

By means of the transmission means 10, cutter set moving means 33 and frame lifting means 34, the cutter sets 31 and 32 may perform three dimensional slitting operation on a carton of different sizes. The cutter set moving means 33 includes a guide means 331 (preferably a screw shaft) located in the second direction and a motor 332. The first cutter set 31 is located at one end of the guide means 331. The second cutter set 32 is also mounted on the guide means 331 but is spaced from the first cutter set 31. When the motor 332 is activated, the second cutter set 32 will be driven to move close to or away from the first cutter set 31. The cutter sets 31 and 32 further engage respectively with a first auxiliary conveyor 313 and a second auxiliary conveyor 323 located thereunder. The auxiliary conveyors 313 and 323 hold and clamp the carton securely when the cutters sets 31 and 32 perform slitting operation on the carton at two lateral sides of the upper lids. The slitting means 30 also may include a plurality of sensors (e.g., microswitches or photo sensors) for measuring relative position of the cutter sets 31 and 32 against the carton so that when the slitting operation is completed, the cutter sets 31 and 32 will be moved back to their initial positions.

There are also two sensors 333 and 334 fixedly mounted respectively at two ends of the cutter set moving means 33 for defining the leftest and rightest position limit of the second cutter set 32 and thus define the smallest and largest carton width this invention is able to process. The sensor 334 which defines the largest width may be selected as the initial position for the second cutter set 32.

On the frame lifting means 34, there also may be provided with a pair of sensors 341 and 342 vertically spaced from each other for defining the highest and lowest height of the carton. The sensor 341 which defines the highest dimension of the carton may be selected as an initial position for the cutter rack 36.

At a lateral side adjacent the first cutter set 31, a pivotal counter balance weight suspending beam switch 37 is provided which has a low end positioned at a height equal to the slitting height of the first cutter set 31. When the frame lifting means 34 moves the cutter rack 36 downward, the lower end of the counter balance weight suspending beam switch 37 will touch the top lid of the carton and generate signals to indicate that the top lid of the carton is reached. The control unit 40 will pick up the signals and informs the cutter sets 31 and 32 to ready slitting operation. The counter balance weight suspending beam switch 37 may also press the top lid of the carton so that the carton may be held securely to smooth slitting operation.

The first cutter set 31 may also provided with a touch sensitive sensor 315. When the cutter set moving means 33 moves the second cutter set 32 which in turn moves the carton toward the first cutter set 31, a side wall of the carton will touch the touch sensitive sensor 315. A signal will be generated and transmitted to the control unit 40 to indicate that the carton is ready for slitting operation. The first and second cutter sets 31 and 32 then will be actuated to start slitting operation.

In the first and second cutter sets 31 and 32, there also may be provided with a plural number of sensors for alerting or stopping slitting operation when the carton exceeds the maximum width or height limit allowed. For instance, a high limit sensor 314 may be provided in front of the first cutter set 31 at one end of the waiting zone 111 and is located slightly above the pivotal end of the counter weight suspending beam switch 37. When a carton moves from the waiting zone 111 to the slitting zone 112 and touches the high limit sensor 314, the control unit 40 will sound an alert signal or stop the slitting operation automatically. Similarly, a width limit sensor 324 may be provided in front of the second cutter set 32 for alerting if the width of the carton exceeds allowable limit.

The operating procedures of this invention may follow the steps set forth below:

1. The first sensor 21 detects there is a first carton being stopped by the first stopper 25 at the waiting zone 111 and generate a signal. The control unit 40 pickups the signal to start the slitting process. The first stopper 25 is moved downward to enable the first carton moving to the slitting zone 112. The width guide posts 28 keeps the first carton at the proper position of the conveyor 11 without skewing sideward. The first and second cutter sets 31 and 32 are at the initial positions.

2. The conveyer 11 to the first carton to the slitting zone 112 and is stopper by the second stopper 26 and detected by the second sensor 25. A signal is generated and sent to the control unit 40 which issues instructions to move the first stopper 25 up again for receiving a next carton to the waiting zone 111. The cutter set moving means 33 and the frame lifting means 34 move respectively the first and second cutter sets 31 and 32 downward and inward slitting to approach the top lid of the first carton located in the slitting zone 112 in front of the second stopper 26.

3. The sensors in the slitting means 30 detect the cutter sets 31 and 32 moving to a predetermined slitting position and trigger the cutter sets 31 and 32 to rotate. The second stopper 26 and the width guide posts 28 are moved downward. The transmission means 10 and the auxiliary conveyors 313 and 323 move the first carton forcefully toward the discharging zone 113 and the two lateral sides of the top lid of the first carton are slitting by the cutter sets 31 and 32 simultaneously.

4. The slitted first carton is moved into the discharging zone 113 and stopped by the third stopper 27. The third sensor 23 detects the arrival of the first carton and generates signals to the control unit 40 which then stops the slitting rotation of the cutter sets 31 and 32.

The second stopper 26 is moved up again to start the slitting process for the next coming carton. The third stopper 27 is moved downward for the silted carton be moved away from the discharging zone 113 for exit or for another slitting operation on another two lateral sides of the first carton.

For slitting more than one carton of different size, the cutter sets 31 and 32 will be moved to the initial positions after each slitting operation cycle. For slitting cartons of same size, the cutter sets 31 and 32 will be moved away sightly (such as 15-30 cm) from the slitting position after a carton has been finished but do not return their initial positions for speeding up slitting operation.

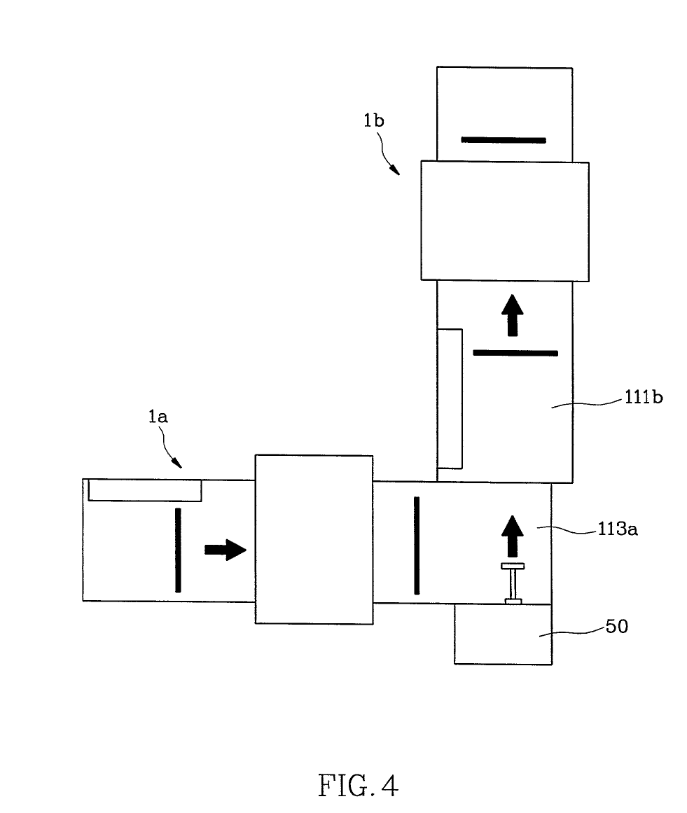

The first cutter set 31 and second cutter set 32 can slit two opposite lateral sides of the carton at one pass. If four lateral sides of the carton need to be silted open, the carton may be turned manually for 90 degrees after the first two lateral sides have been silted open and then be fed to another slitting machine of this invention for process the second two opposite lateral sides. Another way is to use two sets of this invention layed out as shown in FIG. 4.

Two slitting machines 1a and 1b are functionally linked in series and normal to each other. At the discharging zone 113a of the slitting machine 1a. There is a mechanical push bar 50 actuated by the control unit 40 to push the carton processed by the slitting machine la to the waiting zone 111b of the slitting machine 1b for slitting another two lateral sides not yet being silted open. Thus the carton may be processed automatically for all four lateral sides without human intervention.

It may thus be seen that the objects of the present invention set forth herein, as well as those made apparent from the foregoing description, are efficiency attained. While the preferred embodiments of the invention have been set forth for purpose of disclosure, modifications of the disclosed embodiment of the invention as well as other embodiments thereof may occur to those skilled in the art.

For instance, the cutter set moving means 33 and the frame lifting means 34 may be driven by various means known in the art such as screw bar, chain, gear, sprocket, belt, steel wire, gear rack and the like. The means for guiding motion direction of the cutter set moving means 33 and the frame lifting means 34 may be a guide screw bar, a sliding bar, a groove channel, a guide rail and the like. Accordingly, the appended claims are intended to cover all embodiments which do not depart from the spirit and scope of the invention.

What is claimed is:

1. An automatic carton slitting machine for automatically slitting cartons of different size, comprising:
a transmission means for moving cartons along a first direction;
a sensing and positioning means including a plurality of sensors and stoppers for detecting and stopping the cartons at desirable locations in the transmission means;
a slitting means located in a slitting zone of the transmission means including a first cutter set, a second cutter set, a cutter set moving means for moving the second cutter set moving toward or away from the first cutter set along a second direction normal the first direction, a cutter rack for holding the first and second cutter sets and the cutter set moving means, and a stand located in the slitting zone for supporting the cutter rack and a frame lifting means, wherein the first and second cutter sets each includes a rotating cutter saw driven respectively by a motor for performing slitting operation, through coordinated movements among the transmission means, cutter set moving means and frame lifting means, different sizes of carton may be silted open by the cutter sets; and
a control means for coordinating and controlling operation of the transmission means, sensing and positioning means and slitting means.

2. The automatic carton slitting machine of claim 1, wherein the transmission means includes at least one motor which drives at least one conveyor for moving the cartons placing upon the conveyor along the first direction.

3. The automatic carton slitting machine of claim 2, wherein the conveyor includes a plurality of roller bars which may rotate simultaneously at same direction for moving the cartons linearly in rotation direction.

4. The automatic carton slitting machine of claim 3, wherein each stopper is located between a pair of the roller bars and may be moved up above the roller bars for stopping a carton from moving forward or be moved down below the roller bars.

5. The automatic carton slitting machine of claim 1, wherein the sensing and positioning means includes at least a first sensor pairing with a first stopper located in a waiting zone of the transmission means for detecting and holding a first carton in the waiting zones, a second sensor pairing with a second stopper located in a slitting zone of the transmission means for detecting and holding a second carton in the slitting zone and a third sensor pairing with a third stopper located in a discharging zone of the transmission means for detecting and holding a third carton in the discharging zone.

6. The automatic carton slitting machine of claim 5, wherein the first sensor detects the first carton being stopped by the first stopper and triggers the control unit to move the first stopper downward for the first carton moving to the slitting zone be stopped by the second stopper, the cutter set moving means and the frame lifting means moving the first and second cutter sets to slit the carton at the slitting zone, the slitting being stopped when a silted carton reaching the third stopper at the discharging zone.

7. The automatic carton slitting machine of claim 6, wherein the slitting zone further includes a plurality of width guide posts linearly located along the carton moving direction and being engaged with the second stopper and being movable up or down simultaneously with the second stopper.

8. The automatic carton slitting machine of claim 5, wherein the sensors are photo sensors.

9. The automatic carton slitting machine of claim 5, wherein the sensors are microswitches.

10. The automatic carton slitting machine of claim 1, wherein the first cutter set is stationarily located at a lateral side of the cutter rack, the cutter set moving means including a guide means and a motor for moving the second cutter set toward or away the first cutter set.

11. The automatic carton slitting machine of claim 10, wherein the first and second cutter sets have respectively a first and second auxiliary conveyor for clamping and moving the carton in the slitting zone in the first direction for the first and the second cutter sets to slit open two lateral sides of an upper portion of the carton.

12. The automatic carton slitting machine of claim 11, wherein the first and second cutter sets have adjustable slitting angle and may slit the carton at ninety degrees, forty-five degrees, sixty degrees or other angles desired.

13. The automatic carton slitting machine of claim 1, wherein the slitting means has a plurality of sensors for measuring distance between the cutter sets and the carton.

14. The automatic carton slitting machine of claim 13, wherein the cutter rack has a pivotal counter balance weight beam switch located at a lateral side thereof facing the first cutter set, the switch has one end at a height approximating the first cutter set slitting height for generating signal to the control unit to indicate that the first cutter set has been reaching silting height desired and for pressing a top surface of the carton to facilitate carton slitting operation.

15. The automatic carton slitting machine of claim 13, wherein the first and second cutter sets have respectively a plurality of sensors for generating alerting signals or stopping slitting operation when the carton exceeds a predetermined maximum height or width.

16. The automatic carton slitting machine of claim 13, wherein the sensors are microswitches.

17. The automatic carton slitting machine of claim 13, wherein the sensor are photo switches.

18. The automatic carton slitting machine of claim 1, wherein two said slitting machines are aligned in series and normal to each other so that the first and second cutter sets of a first slitting machine may slit two opposite top lateral sides of the carton while the first and second cutter of a second slitting machine may slit another two opposite top lateral sides of the carton without turning the carton.

19. The automatic carton slitting machine of claim 1, wherein the first and second cutter set moves respectively outward and upward slightly without returning to their initial positions for cartons of same or similar size for improving slitting efficiency.

20. The automatic carton slitting machine of claim 1, wherein the frame lifting means moves the cutter set moving means in a third direction normal to the first and second direction, wherein through coordinating the transmission means, cutter set moving means and frame lifting means the cutter set being able to perform three dimensional slitting operation against the carton of different sizes.
